(19) United States
(12) Patent Application Publication
(10) Pub. No.: US 2016/0379425 A1
(43) Pub. Date: Dec. 29, 2016

(54) MOVABLE BARRIER SYSTEM WITH MODULAR NETWORK INTERFACE

(71) Applicant: VIKING ACCESS SYSTEMS, LLC, Irvine, CA (US)

(72) Inventor: Ali Tehranchi, IRVINE, CA (US)

(21) Appl. No.: 14/752,604

(22) Filed: Jun. 26, 2015

(51) Int. Cl. G07C 9/00

(52) U.S. Cl. CPC G07C 9/00007; G07C 9/00309; G07C 2009/00769

(57) ABSTRACT

The invention involves a movable barrier system that utilizes an access device with a modular network interface capable of accessing a client device via different available networks. The access device includes a user interface for requesting access to the client device, a modular network interface with a plurality of network adapters capable of accessing the client device via a first network according to a first protocol, and via a second network according to a second protocol, and a controller in communication with the user interface, the modular network interface, and a movable barrier operator that controls movement of a movable barrier. The controller may be configured to detect an availability of a network adapter of the modular network interface, and select one of the network adapters according to a programmable priority, in order to establish the communication with the client device and send a command signal to the movable barrier operator in order to actuate the movable barrier.

### TECHNICAL FIELD OF THE INVENTION

The present invention relates generally to a system and method for controlling access through a movable barrier. More specifically, the invention relates to a movable barrier system that utilizes an access device with a modular network interface capable of accessing a client device via different communication networks.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Typically, access to a secure location, such as a gated area, building, parking structure or walkway, has been controlled in one of two ways. The first is through the use of a remote control, keypad for inputting a passcode, radio transmitter, and/or other similar remote devices. The second method requires that the user attempting to gain access communicate with an internal party, who then grants access to said user. The user will normally initiate communication via some form of access device, located on the outside of the secure location, which may communicate to a separate client device with the internal party. The communication link between the access device and the client device is often some dedicated telephone line, wired or wireless intercom, dedicated internet connection, or other network setup. Hence, each method of communication requires that the access device be designed and manufactured specifically for that method of communication, and therefore each access device can only be used for one such method of communication. This presents several problems.

First, any time there is a desire to change or update the communications system the access device must be replaced for one that is compatible with the updated communications system. This naturally requires additional expenditures and resources. Often, this problem arises when a building, parking structure, or any other premise that relies on an access device for their movable barrier system, changes or updates their communication network. That is, whether the premises implements a dedicated communication network for the access device, or shares a communication network, if a new network is introduced, the access device will become obsolete.

Similarly, manufacturers may be required to provide different models for different needs; for example, while some premises are better suited for wired communication networks, other premises may be better suited for wireless communication networks. Thus, it is desirable to have an access device easily adaptable to a variety of communication networks, avoiding compatibility issues presented with the different types of network communications available in the field.

Another problem occurs in the event that the dedicated communication network between the access device and the client device were to malfunction, or becomes unavailable. This failure may result in complete paralysis of the movable barrier system as communication between the access device and the client device is impossible, and the user would be unable to gain access whenever authorization is required. Thus, it is desirable to have a movable barrier system that implements multiple communication networks and an access device capable of communication with any of the available networks.

Therefore, there exists a previously unappreciated need for an improved and more efficient means of enabling multiple communication means between users attempting to gain access to a secure location and the parties granting such access, without requiring several different devices to do so. Furthermore, there is a need to provide a means of ensuring that communication between parties will not be terminated if one method of communication malfunctions or fails to work properly. It is to these ends that the present invention has been developed.

### BRIEF SUMMARY OF THE INVENTION

To minimize the limitations in the prior art, and to minimize other limitations that will be apparent upon reading and understanding the present specification, the present invention describes a movable barrier system that utilizes an access device with a modular network interface capable of accessing a client device via different communication networks.

A system for controlling a movable barrier, in accordance with one embodiment of the present invention, comprises: a movable barrier; an access device including a modular network interface with a plurality of ports capable of accessing a client device via a wide area network according to a first protocol, and via a local area network according to a second protocol, the access device including a controller configured to: establish a communication with the client device, receive a command from the client device for controlling the movable barrier, and generate a command signal based on the command; and a movable barrier operator in communication with the access device, the movable barrier operator including a motor mechanically coupled to the movable barrier, and configured to: receive the command signal from the access device, and actuate the movable barrier in response to the command signal.

A method for controlling a movable barrier, in accordance with one embodiment of the present invention, comprises: requesting access to a client device using a modular network interface with a plurality of ports capable of accessing the client device via a wide area network according to a first protocol, and via a local area network according to a second protocol; establishing a communication with the client device; receiving a command from the client device for controlling the movable barrier; generating a command signal based on the command from the client device; sending the command signal from the access device to a movable barrier operator; and actuating the movable barrier in response to the command signal.

An access device for controlling access via a movable barrier, in accordance with one embodiment of the present invention, comprises: a user interface for requesting access to a client device; a modular network interface with a plurality of ports capable of accessing the client device via a wide area network according to a first protocol, and via a local area network according to a second protocol; and a controller in communication with the user interface, the modular network interface, and a movable barrier operator that controls movement of a movable barrier, the controller configured to: establish a communication with the client device, receive a command from the client device for controlling the movable barrier, generate a command signal based on the command from the client device, and send the command signal to the movable barrier operator in order to actuate the movable barrier.

It is an objective of the present invention to provide an access device that may be universally implemented with a movable barrier system.

It is another objective of the present invention to provide an access device that is compatible with multiple network communication protocols.

It is yet another objective of the present invention to provide an easily updatable movable barrier system.

These advantages and features of the present invention are not meant as limiting objectives, but are described herein with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of the various embodiments of the invention. Furthermore, elements that are known to be common and well understood to those in the industry are not depicted in order to provide a clear view of the various embodiments of the invention. The drawings that accompany the detailed description can be briefly described as follows:

FIG. 1 depicts a movable barrier system in accordance with one embodiment of the present invention.

FIG. 2 depicts a movable barrier system including several components for an access device, in accordance with one embodiment of the present invention.

FIG. 3 is a flowchart illustrating a method for controlling access through a movable barrier in accordance with one embodiment of the present invention.

### DESCRIPTION OF THE INVENTION

In the following discussion that addresses a number of embodiments and applications of the present invention, reference is made to the accompanying figures, which form a part thereof. Depictions are made, by way of illustration, of specific embodiments in which the invention may be practiced; however, it is to be understood that other embodiments may be utilized and changes may be made without departing from the scope of the present invention.

In the following detailed description, a movable barrier system may be any system that controls a movable barrier to an entry, an exit, or a view. The movable barrier could be a door for a small entity (i.e. a person), or a gate for a large entity (i.e. a vehicle), which may swing out, slide open, roll upwards, or operate in any other manner suitable to control access through the entry, exit, or view. The operator that controls the barrier may move the barrier from an open position to a closed position and vice-versa. The operator may be automatic and may be controlled locally or remotely. Additionally, an operator may comprise of one or more motors for moving one or more barriers, or one or more actuators configured to open, close, lock, unlock, or otherwise control movement of a barrier. A system in accordance with the present invention also includes an access device. An access device may be a device separate or integral with the operator, which may be used to communicate with a client device for obtaining access through the movable barrier. The access device is typically located remotely from the client device somewhere near the movable barrier; as users approach the movable barrier, they may utilize the access device to communicate with the client device in order to gain entry. The access device communicates with the client device via a communications network.

In the present disclosure, a communications network may refer to a wide area network (WAN), a local area network (LAN), a wireless personal area network (WPAN), or a plain old telephone service (POTS) network. A WAN may be a cellular wide area network, and a LAN, which may include a wireless local area network (WLAN), may be any local area network that provides voice and data communication—typically via an enterprise server with high speed wired or wireless internet access. A WPAN, may be a short ranged communications network built with known technologies such as ZigBee™, Bluetooth™, Wi-Fi™, NFC, or any other suitable protocols.

Generally, the invention involves a movable barrier system that utilizes an access device with a modular network interface capable of accessing a client device via different communication networks. The modular network interface includes a plurality of independent network interface controllers, cards, or adapters, configured to communicate with different networks using different protocols. In exemplary embodiments, the plurality of network adapters comprise of stackable network adapters, which may be managed by a network interface manager that communicates the plurality of network adapters to a controller of the access device. The controller of the access device may be configured to detect and identify each of the plurality of network adapters, and select an available network according to a programmable priority protocol. The access device includes a user interface such as a display and keyboard, for users to locate or request access to a client device. The access device is further configured to communicate with a movable barrier operator coupled to a movable barrier. When a user requests access to a client device, the controller detects an available network, and connects to the available network using one of the network adapters of the modular network interface. The established communication between the access device and the client device then allows the client device to send an authorization signal to the access device for controlling the movable barrier. The access device communicates this authorization signal to the operator in order to actuate the barrier.

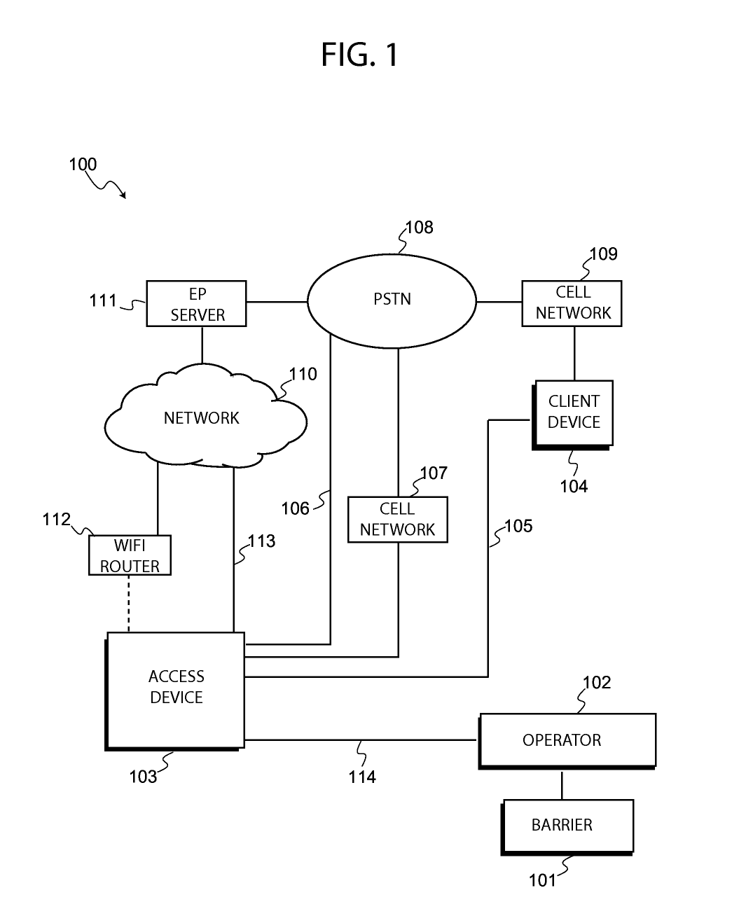

Turning now to the figures, FIG. 1 depicts a system, in accordance with the present invention, which includes a modular access device configured to allow multiple means of communication with a client device. Furthermore, such system includes a movable barrier operator configured to generate a barrier command in response to an authorization signal from the client device. More specifically, FIG. 1 shows system 100, which includes a movable barrier (barrier 101), a movable barrier operator (operator 102), access device 103, and client device 104.

Barrier 101 may be any type of barrier as mentioned above. For example, barrier 101 may be a gate to a gated community, a parking structure, a walkway, or any secured area. In one embodiment, barrier 101 is a sliding gate; in another embodiment, barrier 101 is a swing gate; in yet another embodiment, barrier 101 may be a lockable doorway at the entrance to a building, or a lockable gate on a walkway.

Operator 102 may be any type of movable barrier operator suitable to actuate, operate, or otherwise control access via barrier 101. Thus, operator 102 may be a swing gate operator that swings open, a sliding gate operator that moves a gate on a track, a locking mechanism that locks and unlocks a door to an entry, or any other type of operator suitable for controlling the type of movable barrier that may be implemented with system 100. Typically, operator 102 may include a motor mechanically coupled to barrier 101, and is in communication with access device 103. In alternative embodiments, access device 103 is integral with operator 102 so that both devices are housed together. When operator 102 receives a command signal from access device 103, operator 102 engages, drives, or actuates its motor in order to move or control barrier 101 and grant a user access by for example moving or unlocking barrier 101.

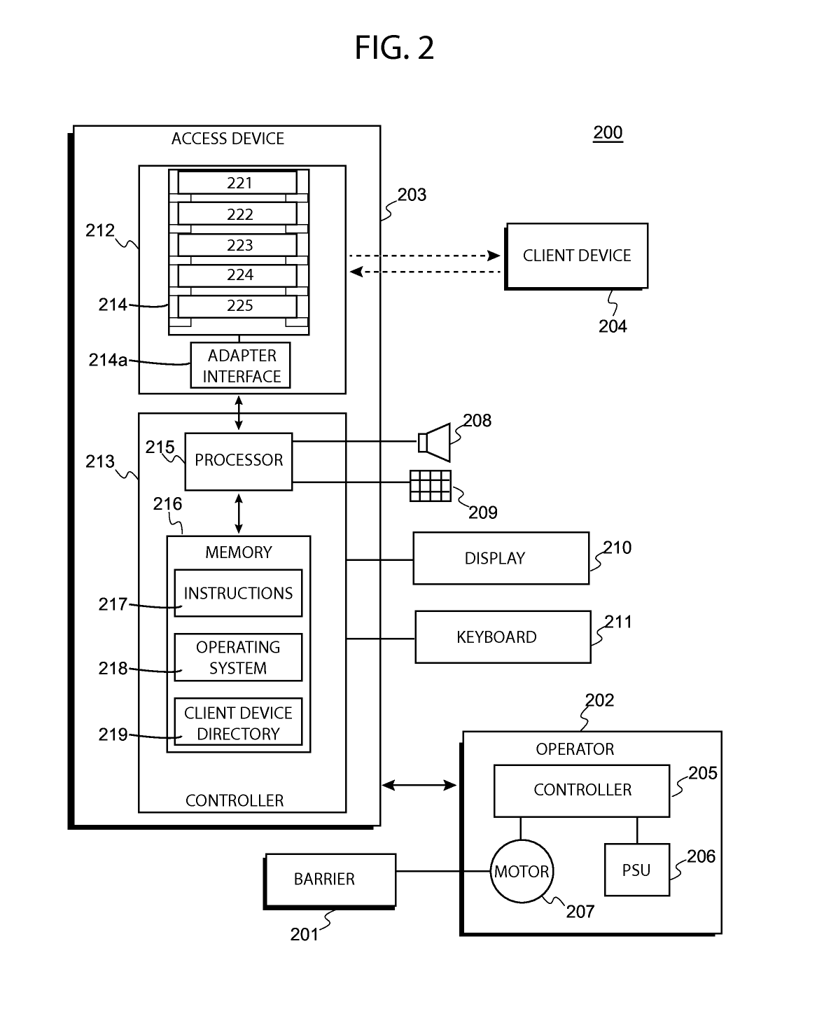

Access device 103 may be any type of communication device suitable to establish and relay communication between the user and another party. As such, access device 103 should be configured to establish communication with client device 104. As will be described in more detail below with reference to FIG. 2, access device 103 may include a two-way speaker and/or video screen, which enables the user to contact the other party.

Access device 103 may establish a communication with client device 104 in several ways. For example, and without limiting the scope of the present invention, access device 103 may communicate with client device 104 by using a dedicated phone line 105 wherein client device 104 is for example a wired intercom system. Access device 103 may communicate with client device 104 by using a POTS dedicated line 106. Access device 103 may communicate with client device 104 by using a cellular network interface via cellular network 107, which may connect to a public switch telephone network (PSTN 108), wherein client device 104 is for example a cellular phone connected to cellular network 109. Access device 103 may communicate with client device 104 by using network 110 such as the internet to access an enterprise server 111 that may implement technologies such as Voice over Internet (VoIP) protocols or other voice and data communication protocols; server 111 may be accessed by access device 103 via wireless router 112, or via a direct Ethernet cable 113. Naturally, other known available method of communication may be implemented without deviating from the scope of the present invention.

Note that not all means of communication mentioned above need be made available to access device 103. In fact, it may be undesirable to implement so many communication networks for access device 103's use; however, at east for illustrative purposes, system 100 is shown with several available communication networks.

In order to provide compatibility with the wide variety of communication means that may be available to system 100, access device 103 includes a modular network interface that includes a plurality of network adapters capable of using any one of the available communication methods. As such, whether a particular location in which system 100 is to be installed includes one or more available networks, access device 103 may be easily implemented. Moreover, as will be described below, if multiple networks or communication means are available to system 100, access device 103 may be configured to communicate with each and every one of the networks, however selectively choosing which network to utilize depending on availability and a programmable priority protocol. As such, in addition to offering a wide range of compatibility with various networks, access device 103 may use alternative communication means in the event of a malfunction with the primary network used to communicate with client device 104.

Access device 103 is also configured to communicate with operator 102 via movable barrier operator communications means 114. As mentioned above, when a user of client device 104 authorizes access through barrier 101, that authorization may be communicated to operator 102. For example, an authorization signal may be sent to access device 103 from client device 104, and access device 104 may in turn rout the authorization signal, or transmit another signal, or otherwise generate a command signal for operator 102 to actuate barrier 101. As such, communications means 114 may be, without limiting the scope of the present invention, a radio frequency, a power line communication (PLC) protocol, a dedicated local WPAN, or any other suitable protocols for establishing a short ranged communication between access device 103 and operator 102.

Turning now to the next figure, FIG. 2 depicts a movable barrier system including several components for an access device, in accordance with one embodiment of the present invention. More specifically, FIG. 2 shows system 200, which includes barrier 201, operator 202, access device 203 and client device 204.

Operator 202 includes typical components such as a controller 205 which supplies power from power supply unit (PSU) 206 to motor 207 in order to move or control barrier 201. Controller 205 is typically configured to communicate with access device 203 so that access device 203 may signal operator 202 to actuate or move barrier 201 after receiving an authorization signal from client device 204.

Motor 205 may be any type of motor or actuator suitable for controlling barrier 201—for example, moving barrier 201 between an open and closed position, or locking or unlocking barrier 201—depending on the type of barrier for which system 200 may be implemented. As such, motor 205 may be a Lorentz force motor, a hub motor, a DC motor, an AC motor, or any other type of motor or actuator known in the art and suitable for controlling barrier 201.

PSU 206 is typically configured for supplying power to the various components of operator 202 from a suitable power source. PSU 206 may comprise any number of configurations including access to a back-up power supply, a rechargeable means, or any other means of supplying power to operator 202 components.

Access device 203 includes typical components for enabling a communication with client device 204—such as speakers 208, microphone 209, display 210, and keyboard 211. Any type of speakers, microphones, displays or keyboards may be implemented without deviating from the scope of the present invention, so long as these components provide an adequate user interface for users to request access to client device 204, and properly communicate with a user of client device 204 once access device 203 establishes the communication.

Access device 203 comprises modular network interface 212 and controller 213, which enable access device 203 to (among other things) detect whether a particular network is available, and select an available means of communication to establish a communication with client device 204.

Client device 204 may be any type of communications device suitable for communicating with a user of access device 203 and transmitting an authorization signal for controlling movement or operation of barrier 201. As such, client device may be: a wired or wireless intercom inside a building or structure associated with barrier 201; a telephone on a POTS land line; a telephone on a cellular network; a smartphone on a VoIP network; a tablet; a computer; or any other device capable of telecommunication with access device 203.

Modular network interface (module 212) may include a plurality of independent network interface controllers, cards, or adapters, each configured to communicate with a different network using different protocols. In exemplary embodiments, the plurality of network interface controllers comprise of several stackable network adapters 214, which may be managed by controller 213 of access device 203. In exemplary embodiments, module 212 includes a physical component as well as a software component or set of instructions for identifying which of the plurality of network adapters 214 has been connected to a network, and/or which network should be utilized by access device 203 in order to establish a communication with client device 204. In other embodiments, controller 213 includes instructions for: identifying each of the network adapters 214, determining whether any are connected and available, and using a programmable priority protocol to select one of the network adapters 214 for communicating with client device 204. Moreover, in the event a previously available network becomes unavailable, controller 213 may be configured to simply use another available network.

Adapter interface 214a may be any suitable interface connecting the network adapters 214 of module 212 to controller 213, and facilitating the identification of each network adapter for determining which adapter and therefore which network is available. Several types of adapter interfaces may be implemented without limitation: in one embodiment, adapter interface 214a may comprise of a series of jumpers or conductors coupled to each of the network adapters 214; in another embodiment, adapter interface 214a may comprise of a series of passive components such as resistors or capacitors, which may be utilized for identification of each network adapter; in another embodiment, adapter interface 214a may comprise of a bus communicating each network adapter and utilizing a digital signature to identify each network adapter; or in another embodiment, adapter interface 214a may be configured to implement time-division multiplexing in order to implement an alphanumeric identification, which may be used in connection with a bus.

In the illustrative embodiment shown, network adapters 214 include adapters 221, 222, 223, 224, and 225—each configured to connect to a different type of communications network. For example, and without limiting the scope of the present invention, adapter 221 may be configured for a dedicated direct line, wherein client device 204 is for example a wired intercom system); a network interface controller 222 for using a POTS dedicated telephone line; a network interface controller 223 for using a cellular network; and an network interface controller 224, and a wireless network interface controller 225 for using voice communication services or data or messaging services over the internet. Naturally, other known available method of communication may be implemented without deviating from the scope of the present invention; as such, other network interface controllers, adapters or interfaces may be incorporated with module 212.

Network adapters 221 and 222 may comprise telephony interface modules such as analog interface cards that provides support for analog or POTS lines and phones; these may include modules for Foreign Exchange Office or FXO and Foreign Exchange Station or FXS interfaces. The analog cards may provide varying modular port options, and include hardware-based echo cancellation or other known technology that improves the quality of communication.

Network adapter 223 may be a cellular network adapter for using a cellular telecommunication system such as CDMA (code division multiple access) and variants such as GSM (global system for mobile communications standard), GPRS (general packet radio system), 2.5G, 3G, and 4G systems such as UMTS (universal mobile telecommunication service) or UMTS based systems, integrated digital enhanced networks and variants or evolutions thereof.

Network adapter 224 may comprise of an Ethernet card suitable for connecting access device 203 to a LAN in order to use VoIP or other similar methods in a communication with client device 204.

Network adapter 225 may comprise of a wireless internet card suitable for connecting access device 203 to a WLAN in order to use VoIP or other similar methods in a communication with client device 204.

The plurality of network adapters may implement a variety of protocols depending on the adapter selected to communicate with the client device. As mentioned above, these protocols may include, a cellular telecommunication protocol such as a CDMA protocol or a GSM protocol; a WiFi protocol such as an IEEE-802.11X wireless protocol; or a VoIP protocol.

Controller 213 may comprise of one or more processors typically including a voice and data processor 211 in communication with a memory 223. Processor 215 may be any known processor suitable for communicating with client device 204 via the various network protocols for both voice and data traffic, and may include one or more microprocessors, digital signal processors, and other integrated circuits suitable for adequate signal processing duties for any WAN and W-LAN. Typically, processor 215 is configured to encode and decode voice and data messages to provide signals suitable for a transducer or further processing by the controller 213 in order to relay or generate signals for operator 202 to actuate barrier 201.

In some embodiments, controller 213 may be configured to detect and identify which of the available network adapters of module 212 is connected and available for use (i.e. the network it is designated for is available for communications with client device 203). For example, and without limiting the scope of the present invention, in one embodiment controller 213 may simply detect a jumper/conductor coupled to each of the network adapters; in another embodiment, a passive component such as a resistor or capacitor may be utilized for identification of each network adapter; in another embodiment, a digital signature may be utilized to identify each network adapter; or in another embodiment, an alphanumeric identification may be used in connection with a bus utilizing a time multiplexing system.

Memory 216 that may be a combination of known RAM, ROM, EEPROM or magnetic memory, which may be used to store among various other items or software programs, a network priority protocol, procedure, processing routine, or set of instructions 217. Instructions 217 may include instructions to detect the availability of each of the plurality of network interface adapters of the modular network interface, and selecting one of the available network interface adapters according to a programmable priority, in order to establish the communication with the client device. The programmable priority may be determined by a user depending on the communication networks available to system 200. For example, if high speed internet is available via both wired and wireless means, as well as a telephone line, access device 203 may be programmed to select one of those as the primary, another as the secondary, and so on. If the primary is unavailable, the next available communications means may be selected.

Memory 216 may also be used to store an operating system 218 with data and variables as is known, as well as a client device directory 219. Operating system 218 may offer a graphical user interface for users to be able to search client device directory 219 in order to locate and request access to client device 204. Use of operating system 218 and access to client directory 219 may be facilitated by display 210 and keyboard 211.

As such, controller 213 of access device 203 may be configured to detect an availability of each of the plurality of network adapters of the modular network interface, select one of the network adapters according to a programmable priority, establish a communication with the client device, receive an authorization signal from the client device for controlling the movable barrier, and generate a command signal based on the authorization signal. The command signal may be sent to operator 202 in order to actuate barrier 201. Moreover, controller 213 may further be configured to identify an unavailable network adapter from the plurality of network adapters, determine whether the unavailability of the unavailable network adapter is due to a malfunction, and generate an error log associated with the malfunction.

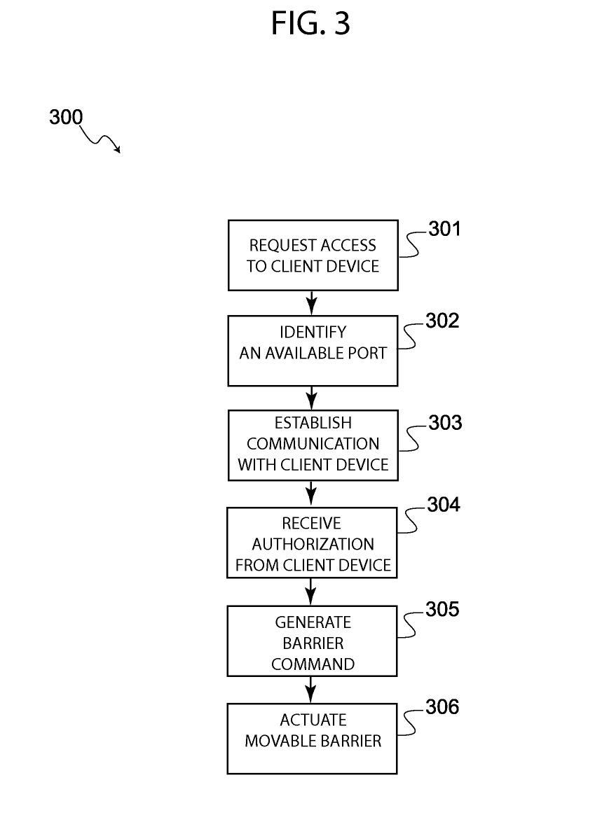

Turning now to the next figure, FIG. 3 is a flowchart illustrating a method for controlling access through a movable barrier in accordance with one embodiment of the present invention. More specifically, method 300 is shown including several steps. Notably, although the steps of method 300 are depicted in a particular sequence, other alternative sequence of the steps may be performed without deviating from the scope of the present invention.

In step 301, access to a client device may be requested. This may include receiving a request to access a client device from an access device including a modular network interface with a plurality of network adapters capable of accessing the client device via a first network according to a first protocol, and via a second network according to a second protocol. Typically, a user will approach an access device in accordance with the present invention and via a user interface, such as a display and keyboard, the user will find a user associated with a client device, which may be contacted. The user of the client device presumably has authorization to grant access to the requesting user. A controller of the access device may receive user input concerning a request to access or communicate with the client device of the user with authorization to grant access.

In step 302, the controller situated within the access device identifies available networks by checking which ports have been connected or which network interfaces are being used and working properly. In one embodiment, this step also includes detecting an availability of each of the plurality of ports of the modular network interface and selecting one of the ports according to a programmable priority, in order to establish the communication with the client device. In another embodiment, this step includes detecting and/or identifying an availability of each of the plurality of network adapters of the modular network interface, and selecting one of the network adapters according to a programmable priority.

In step 303, access with the client device may be established via one of the available networks. This may simply include establishing a communication with the client device using the selected network adapter.

In step 304, an authorization signal may be received from the client device for controlling the movable barrier. This may be initiated via a user input, a voice command, a textual command, or any other type of input by a user of the client device.

In step 305, a command signal based on the authorization signal from the client device may be generated, and sent to the movable barrier operator in order to actuate the movable barrier.

In step 306, the movable barrier operator engages or actuates its motor in order to move the barrier and provide the requesting user access.

A movable barrier system with modular network interface has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

1. A system for controlling a movable barrier to a secured location, comprising:
an access device including a user interface situated in a fixed proximity to the movable barrier so that the access device is on the outside of the secured location, and a modular network interface with a plurality of network adapters capable of accessing a client device via a first network according to a first protocol, and via a second network according to a second protocol, the access device including a controller configured to:
receive a request from a first user of the access device to communicate with a second user of the client device via the access device for acquiring authorization to access the secured location from the second user of the client device;
detect an availability of each of the plurality of network adapters of the modular network interface,
select one of the network adapters according to a programmable priority,
detect an unavailability of the network accessed via the selected network adapter, the unavailability due to a malfunction or routine maintenance of the system;
select another of the network adapters according to the programmable priority;
establish a communication with the client device,
receive an authorization signal from the client device the authorization initiated by the second user of the client device for controlling the movable barrier, and
generate a command signal based on the authorization signal; and
a movable barrier operator in wired communication with the access device, the movable barrier operator including a motor mechanically coupled to the movable barrier, and configured to:
receive the command signal from the access device, and
actuate the movable barrier in response to the command signal.

2. The system of claim 1, wherein the first protocol comprises a cellular telecommunication protocol.

3. The system of claim 2, wherein the cellular telecommunication protocol comprises a CDMA protocol or a GSM protocol.

4. The system of claim 1, wherein one of the plurality of network adapters comprises a POTS interface.

5. The system of claim 2, wherein the second protocol comprises a WiFi protocol.

6. The system of claim 5, wherein the WiFi protocol comprises an IEEE-802.11X wireless protocol.

7. The system of claim 2, wherein the second protocol comprises a Voice over Internet Protocol (VoIP).

8. The system of claim 2, wherein the controller is further configured to:
identify an unavailable network adapter from the plurality of network adapters;
determine whether the unavailability of the unavailable network adapter is due to a malfunction; and
generate an error log associated with the malfunction.

9. The system of claim 1, wherein the modular network interface comprises a stackable modular network interface, and the plurality of network adapters may be vertically stacked.

10. A method for controlling a movable barrier from an access device, comprising:
receiving a user request from a first user of the access device to communicate with a second user of a client device, the access device including a user interface situated in a fixed proximity to the movable barrier so that the access device is on the outside of the secured location, and a modular network interface with a plurality of network adapters capable of accessing the client device via a first network according to a first protocol, and via a second network according to a second protocol;
detecting an availability of each of the plurality of network adapters of the modular network interface;
selecting one of the network adapters according to a programmable priority;
detecting an unavailability of the network accessed via the selected network adapter, the unavailability due to a malfunction or routine maintenance of the system;
selecting another of the network adapters according to the programmable priority;
establishing a communication with the client device using a selected network adapter;
receiving an authorization signal for controlling the movable barrier;
generating a command signal based on the authorization signal;
sending the command signal from the access device to a movable barrier operator; and
actuating the movable barrier in response to the command signal.

11. The method of claim 10, wherein the first protocol comprises a cellular telecommunication protocol.

12. The method of claim 10, wherein selecting one of the network adapters includes selecting a POTS interface.

13. The method of claim 11, wherein the second protocol comprises a WiFi protocol.

14. The method of claim 12, wherein the second protocol comprises a Voice over Internet Protocol (VoIP).

15. The method of claim 11, further comprising:
identify an unavailable network adapter from the plurality of network adapters;
determine whether the unavailability of the unavailable network adapter is due to a malfunction; and
generate an error log associated with the malfunction.

16. An access device for controlling access to a secured location via a movable barrier, comprising:
a user interface for requesting access to a client device, the user interface including a display and a keyboard situated in a fixed proximity to the movable barrier so that the access device is on the outside of the secured location;
a modular network interface with a plurality of network adapters capable of accessing a client device via a first network according to a first protocol, and via a second network according to a second protocol; and
a controller in communication with the user interface, the modular network interface, and a movable barrier operator that controls movement of a movable barrier, the controller configured to:
receive a request from a first user of the access device to communicate with a second user of the client device via the access device for acquiring authorization to access the secured location from the second user of the client device,
detect an availability of each of the plurality of network adapters of the modular network interface,
select one of the network adapters according to a programmable priority,
detect an unavailability of the network accessed via the selected network adapter, the unavailability due to a malfunction or routine maintenance of the system;
select another of the network adapters according to the programmable priority,
establish a communication with the client device,
receive an authorization signal from the client device, the authorization initiated by the second user of the client device,
and
send a command signal, based on the authorization signal, to the movable barrier operator in order to actuate the movable barrier.

17. The system of claim 16, wherein the controller is further configured to:
identify an unavailable network adapter from the plurality of network adapters;
determine whether the unavailability of the unavailable network adapter is due to a malfunction; and
generate an error log associated with the malfunction.

18. The access device of claim 16, wherein one of the network interfaces comprises a cellular telecommunication interface.

19. The access device of claim 16, wherein the plurality of network adapters include a POTS interface.

20. The access device of claim 16, wherein one of the network interfaces comprises a Voice over Internet Protocol (VoIP) interface.
